(19) United States
(12) Patent Application Publication
(10) Pub. No.: US 2006/0139620 A1
(43) Pub. Date: Jun. 29, 2006

(54) Method and apparatus for coherently processing signals from incoherent sources including laser signals

(76) Inventors: Francis W. Hopwood, Severna Park, MD (US); Elbert L. Cole JR., Catonsville, MD (US); John H. Glezen, Woodbine, MD (US)

Correspondence Address: BIRCH STEWART KOLASCH & BIRCH, PO BOX 747, FALLS CHURCH, VA, 22040-0747, US

(21) Appl. No.: 11/076,046

(22) Filed: Mar. 10, 2005

Related U.S. Application Data
(60) Provisional application No. 60/638,515, filed on Dec. 27, 2004.

(51) Int. Cl. G01C 3/08

(52) U.S. Cl. 356/5.15; 356/5.01; 356/5.1

(57) ABSTRACT

A stable optical reference oscillator (SORO) consisting of conventional low power CW source of coherent optical radiation having a relatively narrow bandwidth is mixed, i.e., beat against a sample of an incoherent laser transmit signal and the phase of the resultant signal is recorded. This is then compared to the phase of an ideal pulse of a perfect laser transmitter which was previously generated and recorded. The result is a phase correction term which is used in the subsequent signal processing of the received signals to realign the received laser pulses so that they are phase coherent.

### CROSS REFERENCE TO RELATED APPLICATION

This application claims priority of Provisional application No. 60/638,515, filed Dec. 27, 2004, the entire contents of which are incorporated herein by reference.

### GOVERNMENT INTEREST

This invention was made in the performance of U.S. Air Force Contract No. F33615-02-C-1257 for the U.S. Government, and therefore the U.S. Government has an interest in this application.

### BACKGROUND OF THE INVENTION

This invention relates generally to processing signals generated by and utilized by electronic system sensors such as radars, and more particularly to, but not limited to, laser radars also referred to as “ladars”.

### DESCRIPTION OF RELATED ART

Lasers, by virtue of their short wavelengths, present many benefits to sensor technology. These benefits include but are not limited to compactness, ruggedness, high power, and high pulse rates. Sensors utilizing radiation in the radio frequency (RF) bands have been developed using many techniques to extract maximum information from their surroundings. Most significant and far reaching of these techniques is coherent processing, which requires that each pulse be known completely down to its phase. With this requirement for coherency, it is difficult to achieve directly at RF and virtually impossible within the realm of lasers. The present invention is directed to overcoming this inherent limitation by an indirect method of providing coherency to the received signals.

The present invention will be described hereinafter in terms of laser synthetic aperture radar (SAR). A typical example of such a system is shown and described in a publication entitled “Synthetic-Aperture-Radar Imaging with a Solid-State Laser”, Thomas J. Green, Jr. et al., which was published in Applied Optics on Oct. 20, 1995, in Vol. 34, No. 30, at pp. 6941-6943. As is well known, the SAR technique utilizes the relative transverse motion between the radar and the target by increasing the effective aperture dimension in the direction of motion through appropriate Doppler signal processing. Reference to the publication cited above may be resorted to for a further understanding of this type of technology.

### SUMMARY

The direct method of achieving coherency in a radar system employing pulsed lasers would require that the transmit lasers produce coherent pulses of energy. “Coherent” means that each pulse in the laser signal is identical to the other pulses down to its phase characteristic. For a high power pulse laser required for measurement systems such as air-to-ground laser radars, this is extremely difficult, if not impossible, to achieve due to the fact that in such lasers, the phase is completely random pulse-to-pulse, modulo 2π.

It is an object of the present invention, therefore, to provide a method and apparatus for improving laser signal sensors and more particularly, to overcoming the inherent limitation of the lack of coherency in a relatively high power pulsed laser transmit signal source of a laser radar system. This is achieved by the inclusion of an indirect source of coherence comprised of a stable optical reference oscillator (SORO) consisting of a conventional low power CW source of coherent optical radiation having a relatively narrow bandwidth in frequency for use as a local oscillator for the laser transmit signal pulses. The SORO signal is mixed, i.e., beat against a sample of the incoherent laser transmit signal and the phase of the resultant signal is recorded. This is then compared to the phase of an ideal pulse of a perfect laser transmitter which was previously generated and recorded. The result is a phase correction term which is used in the subsequent signal processing of the received signals to realign the received laser pulses so that they are phase coherent.

In one aspect of the subject invention, it is directed to a system that uses stretch processing, a technique well known in the art, in a synthetic aperture laser (SAR) radar. As such, it includes a deramp laser where the signal is also mixed with the SORO signal and the phase recorded. This phase is also compared against the phase of an ideal pulse with a second phase correction term being generated. Both phase corrections are then used in the post processing portion of the system to correct the received laser signal data for both linearity in slow time and coherency in fast time following detection and prior to SAR processing.

Further scope of applicability for the present invention will become apparent from the detailed description provided hereinafter. It should be understood, however, that the detailed description and the specific example, while indicating the preferred embodiment of the invention, it is provided by way of illustration only since various changes and modifications within the spirit and scope of the invention will become apparent to those skilled in the art from the following detailed description.

### DETAILED DESCRIPTION OF THE DRAWINGS

The present invention will become more fully understood from the following detailed description and the accompanying drawings, which are provided by way of illustration only and thus are not meant to be limitative of the invention, and wherein:

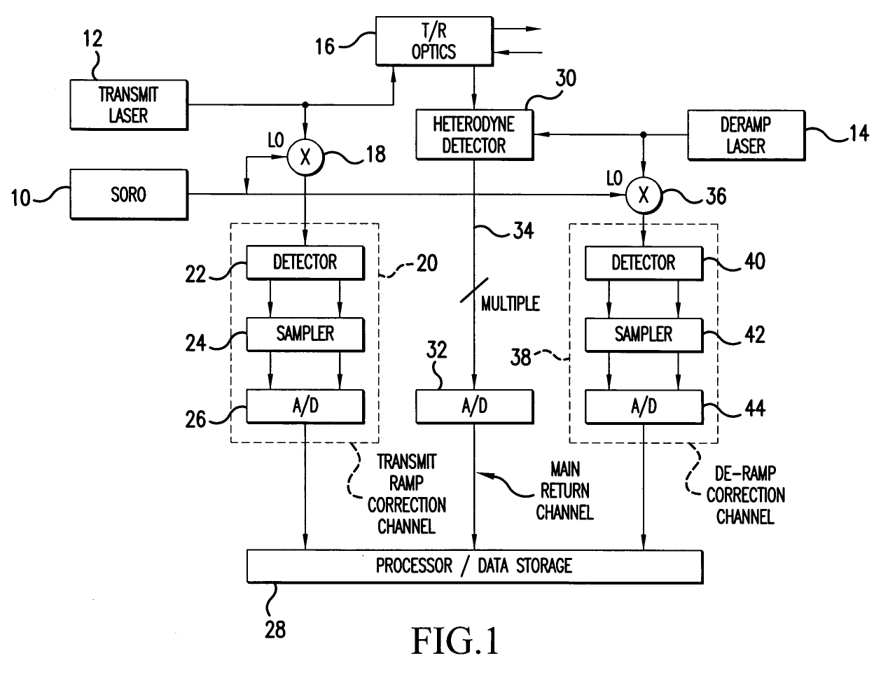

FIG. 1 is a simplified block diagram broadly illustrative of the invention implemented in a synthetic aperture laser radar sensor utilizing stretch signal processing and having a transmit signal correction channel and a deramp signal correction channel;

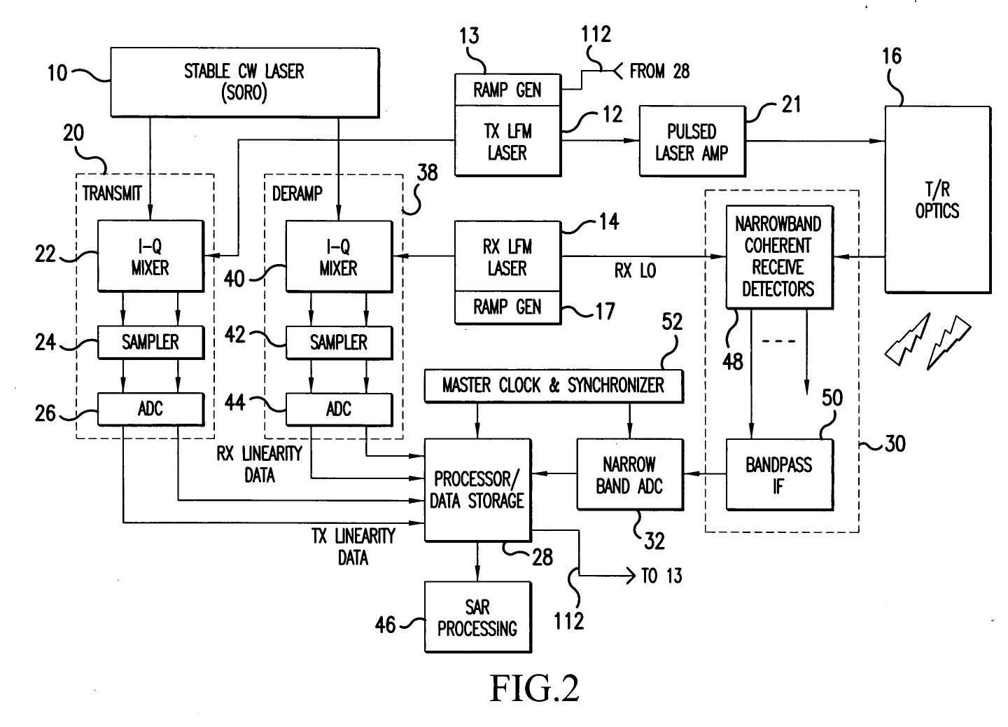

FIG. 2 is a more detailed block diagram of the invention shown in FIG. 1;

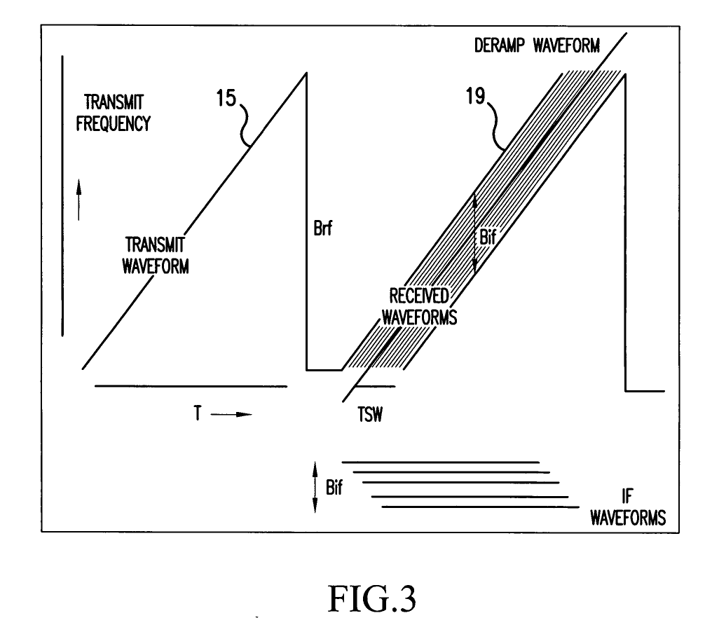

FIG. 3 is a diagram illustrative of transmit and receive waveforms utilized in the subject invention for linearly modulated transmit frequency known in the art as chirp and stretch signal processing in the receive mode;

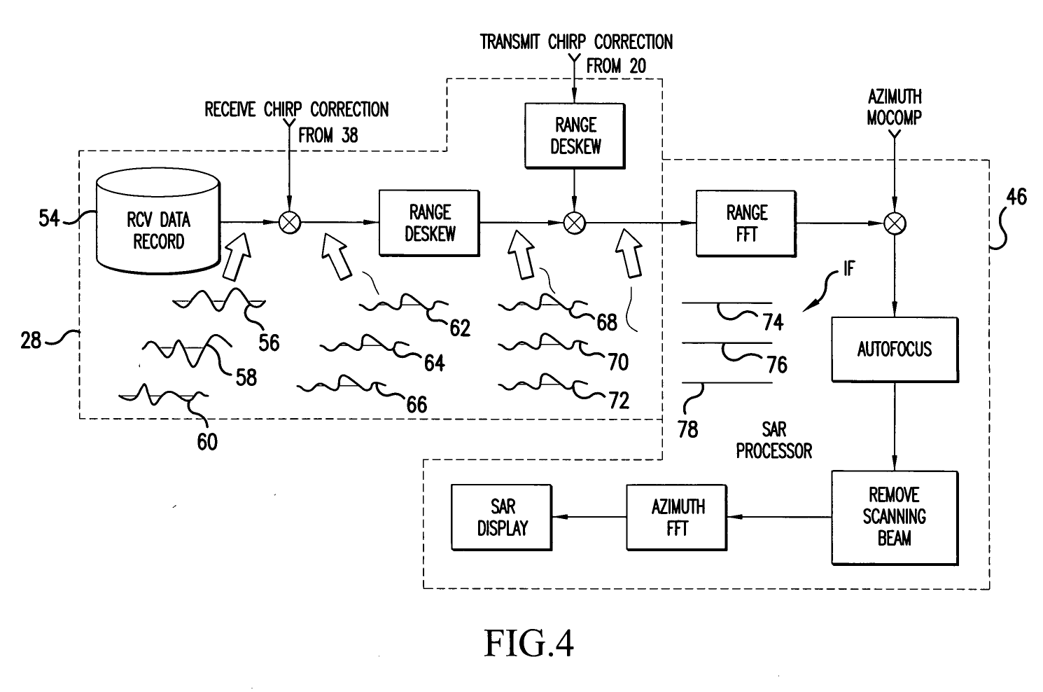

FIG. 4 is a diagram broadly illustrative of the operational sequence of events occurring in the system shown in FIG. 1;

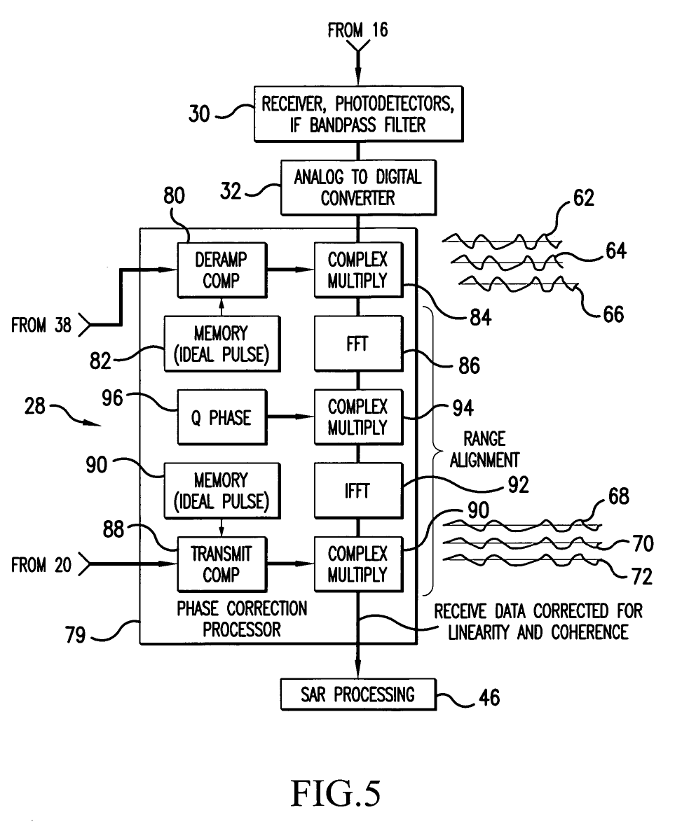

FIG. 5 is a block diagram illustrative of a portion of the processor shown in FIG. 3 for correcting coherency of the received signal data in fast time;

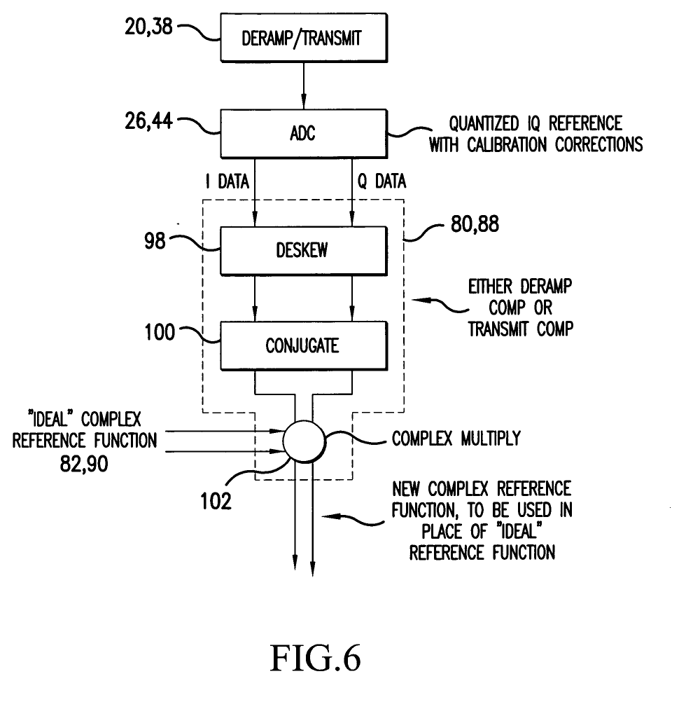

FIG. 6 is a block diagram of a portion of the processor shown in FIG. 5 for providing deramp compensation or transmit compensation of the received laser pulse signals;

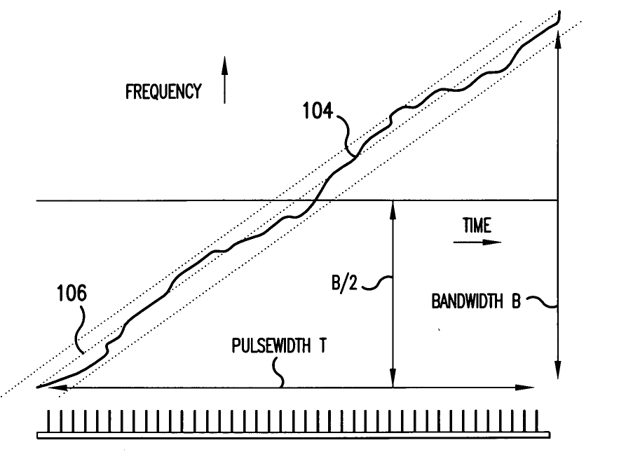

FIG. 7 is a diagram illustrative of the linearity characteristic of the linear frequency modulated transmit laser pulse signal according to the subject invention;

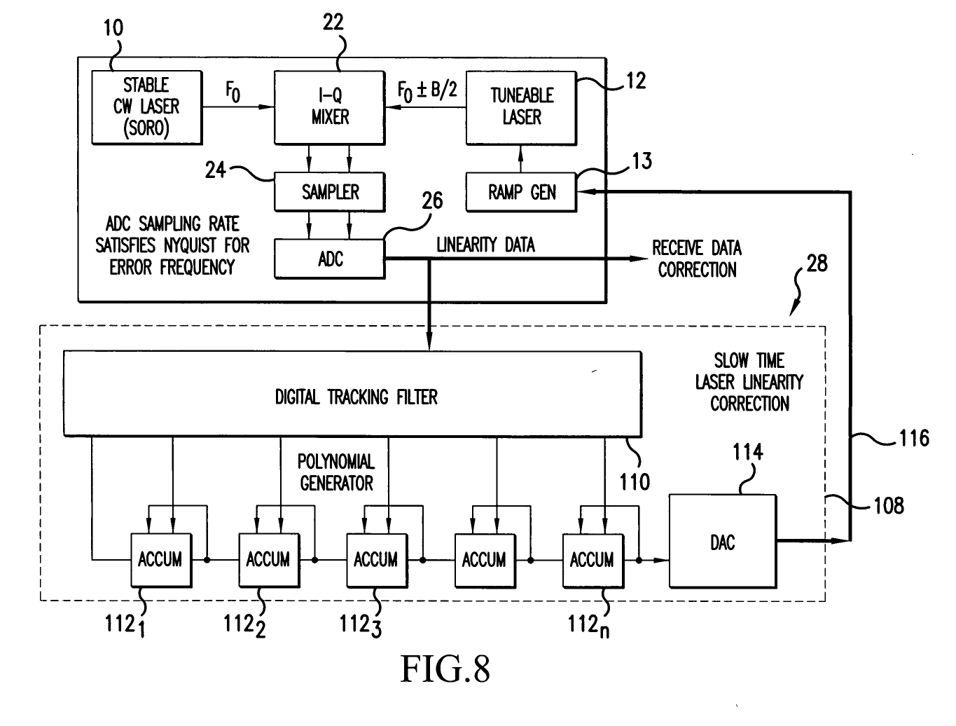

FIG. 8 is a block diagram of a portion of the processor and data storage unit shown in FIG. 2 for improving the linearity of the laser transmit signal in slow time;

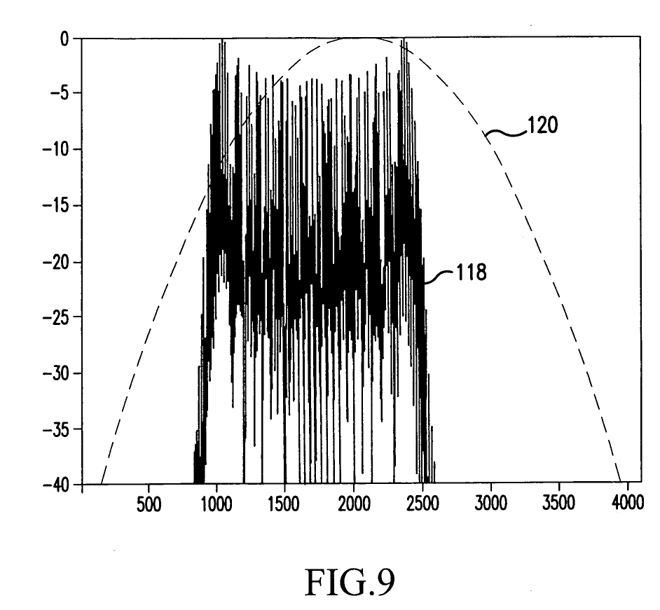

FIG. 9 is a graphical representation of the signal spectrum of the transmit laser before and after a deskew operation performed in the portion of the processor shown in FIG. 4; and

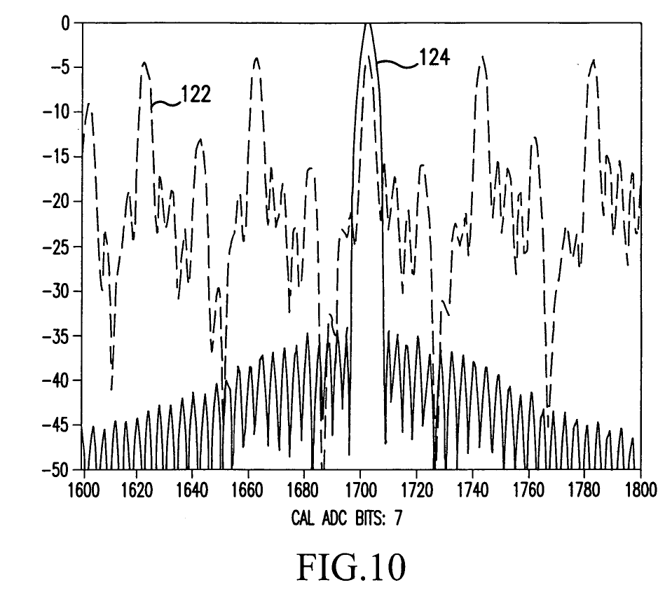

FIG. 10 is illustrative of the impulse response (IPR) before and after coherence correction provided by the apparatus shown in FIG. 5.

### DETAILED DESCRIPTION OF THE INVENTION

Referring now to the drawings, wherein like reference numerals refer to like components throughout, FIG. 1 is broadly illustrative of a block diagram of a linear frequency modulated (chirp) laser radar system in accordance with the subject invention that includes a stable optical reference oscillator (SORO) 10 which is used as a narrow bandwidth (BW) local oscillator and is comprised of a low power, CW source of coherent optical radiation which is used as a phase reference for a pair of optical transmit and deramp lasers 12 and 14. A transmit signal consisting of a train of laser pulses, each having a respective random initial phase, is transmitted and received from a target, not shown, via a transmit/receive (T/R) optics subassembly 16. A sample of the incoherent pulse signal from the transmit laser 12 is mixed, i.e. heterodyned, in an optical signal mixer 18 with the SORO 10 providing an output of a phase difference signal corresponding to the phase difference between the two signals. This phase difference signal is fed to a narrow bandwidth transmit correction channel 20 including signal detector 22, a signal sampler 24, and an analog-to-digital (A/D) converter 26 so as to provide a digitized phase difference signal. The sampled digital phase difference signal is fed to a digital signal processor and data storage unit 28 for subsequent use as will be shown hereinafter in connection with FIG. 4 where it will be compared against the phase of an ideal transmitted laser pulse.

The received laser signal transmitted from transmit/receive (T/R) optics 16 is detected, as shown in FIG. 1, in a conventional heterodyne optical detector 30. Since the preferred embodiment of the invention is intended to use stretch signal processing of the return signals, a deramp laser signal is generated by the deramp laser 14 which is fed to the detector 30 where it is heterodyned with the return laser pulses. The output of detector 30 is fed to an A/D converter 32 in a main return channel 34 which feeds into the processor/data storage 28.

Additionally, a portion of the deramp laser signal from the deramp laser 14 is fed to a second optical signal mixer 36, which beats a portion of the SORO signal with the deramp laser signal with a second phase difference signal being generated and fed into a narrow bandwidth deramp correction channel 38, which also includes a detector 40, a signal sampler 42, and an A/D converter 44 similar to the transmit correction channel 20. The second digitized phase difference signal which is also a digitized phase signal is also fed to the processor/data storage unit 28 for subsequent use as will be explained when FIG. 4 is considered.

Referring now to FIG. 2 which is intended to be further illustrative of the preferred embodiment of the subject invention shown in FIG. 1, in addition to the SORO 10, the transmit laser 12, the receive deramp laser 14, and the T/R optics 16, a ramp signal generator 13 is connected to the transmit laser 12. The frequency of transmit laser pulses is frequency modulated by a ramp (chirp) waveform 15 as shown in FIG. 3. With respect to the deramp laser 14, it is driven by a separate ramp generator 17 which generates a waveform 19 as also shown in FIG. 3. FIG. 2 also discloses that the detector 22 in the transmit correction channel 20 is comprised of a complex signal mixer having inphase (I) and quadrature (O) inputs. The same can be said of the detector 40 in the deramp correction channel 38. It is significant to note also that the samplers 24 and 22 in FIG. 2 provide an analog-to-digital conversion sampling rate which satisfies Nyquist for error frequencies. Accordingly, digital phase data simply are fed to the processor data storage 28 which is shown in FIG. 2 coupled to a SAR processing unit.

FIG. 2 also discloses that the transmit laser 12 is coupled to the transmit/receive optics 16 via a pulsed laser amplifier 21. The heterodyne detector 30 shown in FIG. 1 is shown in FIG. 2 including a set of narrow band coherent receive detectors 48 which receive individual pulses included in the laser receive signal. The detected pulse signals are fed to a bandpass intermediate frequency (IF) filter 50 whose output is then digitally converted by means of a narrow band A/D converter shown by reference numeral 32. As in most, if not all radar systems, all operations are controlled by a master clock and synchronizer 52.

Once samples of the digitized transmit correction phase signal, the deramp correction phase signal and the detected return signals are fed into the processor 28, a sequence of events as shown in FIG. 4 takes place. FIG. 4 is intended to be merely illustrative of a functional sequence, while the apparatus used to implement these functions is shown in FIG. 5.

In FIG. 4, reference numeral 54 is intended to denote a portion of the processor/data storage unit 28 shown in FIG. 1. Reference numerals 56, 58 and 60 denote three successive received return laser pulses. Correction for the deramp signal 19 is applied first via a receive chirp correction from deramp correction channel 38, because all of the errors caused by the deramp signal are consecutively lined up in time immediately after reception. Transmit signal corrections are not yet ready for applications because the dramp process necessarily offsets the return signal slightly in time as shown by reference numerals 62, 64 and 66. This effect is overcome by a deskew operation in which a quadratic phase (Q) is applied to the return pulses 62, 64 and 66, forcing them to become phase coherent as shown by reference numerals 68, 70 and 72. After the deskew operation, the transmit signal corrections are applied, resulting in IF signals 74, 76 and 78. These signals are then fed to a range Fast Fourier Transform (FFT) unit in a conventional SAR processor 46 for generating a display with appropriate azimuth motion compensation, autofocus, scan beam removal and azimuth FFT operations being applied to the image signal data.

Referring now to FIG. 5, the components required for implementing a phase coherency is shown in a phase correction processor portion 79 of the processor/data storage unit 28 shown in FIG. 2. It is comprised of a deramp compensation functional element 80, a first digital memory section 82 in which an “ideal” transmit pulse waveform is generated and stored, a complex (I-Q) multiplier 84, and a FFT section 82. These sub-assemblies provide a deramp signal correction signal providing such signals as shown by reference numerals 62, 64 and 66 in FIG. 4 while a transmit compensation functional element 88, a second memory portion 92, also used to store the waveform of an ideal transmit pulse, a complex multiplier 90, and an inverse IFFT 92 produce a transmit signal correction following the deramp corrected signals being fed to a complex multiplier 94 along with an output from the quadratic (O) phase generator 96 providing such signals as shown by reference numerals 68, 70 and 72 in FIG. 4.

FIG. 6 is intended to illustrate that the deramp and transmit compensation units 80 and 88 shown in FIG. 5 include a deskewing functional element 98 and a complex conjugate functional element 100. These elements feed the I-Q data from A/D converters 26 or 44 (FIG. 2) to a complex multiplier 102 where an “ideal” complex reference function of the ideal pulse waveform is applied either from the memory portion 82 or 90, whereupon their complex components are fed into the complex multiplier 84 or the complex multiplier 90 as shown in FIG. 5.

While coherence correction of the received laser signal is carried out in “fast time”, a correction of the linearity of the linear frequency modulation of the transmit laser pulse is carried out in “slow” time as will now be explained. As shown in FIG. 7, reference numeral 104 depicts an actual frequency variation 104 of the ramped frequency of laser pulses generated by the transmit laser 12, which is inherently unstable in frequency to some extent and having a pulsewidth T, and a bandwidth B. A desired or ideal linear variation of the ramped frequency is shown by reference numeral 106. Linearity of the ramped frequency of the transmit pulse is achieved in slow time in a control loop as shown in FIG. 8 by sampling one half of the digitized phase correction signal from A/D converter 26 over one-half the frequency bandwidth B/2. This portion of the signal is fed to a linearity correction unit 108 of the processor 28, as shown in FIG. 8 of the transmit correction channel 20 and which includes a digital tracking filter 110 connected to the A/D converter 26, a polynomial generator consisting of a set of digital signal accumulators 112₁ . . . 112ₙ, and a digital/analog converter (DAC) 114. The accumulators couple their combined output into the DAC 114 which couples a frequency corrective signal to the ramp generator 13 in the transmit correction channel 12 via signal lead 116.

Thus, two separate and distinct functions are implemented in the subject invention, namely: (1) coherence is imparted to received laser signals generated by an incoherent transmit source; and (2) a linearity correction function is supplied to the ramp generator 13 which controls the frequency of the transmitted pulses rom the T/R optics 16.

FIGS. 9 and 10 respectively illustrate the spectrum of the transmitted signal and the impulse response (IPR) of the received return signal. Reference numeral 118 of FIG. 9 depicts the spectrum of the transmitted laser signal, while reference numeral 120 represents the quadratic phase of the deskew operation. The deskew operation is shown off-centered at the peak of the quadratic phase term; however, this is solved by providing a predistorted reference for a conventional 2D match filter used in the SAR processor to generate a synthetic aperture image generated with the SAR display shown in FIG. 4. Reference numeral 122 of FIG. 10 depicts the IPR before phase and linearity corrections have been made, while a solid line of waveform 124 depicts the IPR after the corrections are made and having a very high single main lobe and a set of side lobes of significantly reduced side lobes as opposed to the multiple main lobes in the IPR 122.

The modulation techniques utilized herein are not meant to be limited to single pulse linear FM stretch and linear FM chirp techniques, but are also applicable for pulse doublets, pulse triplets, pulse n-lets, non-linear FM, bi-phase coding, quadri-phase coding, n-phase coding, Barker coding, Frank coding, complementary coding and Costas coding.

Having thus shown and described what is at present considered to be the preferred embodiment of the invention, it is to be noted that alterations and changes coming within the spirit and scope of the invention as set forth in the appended claims are herein meant to be included.

1. A method of processing signals in a sensor system radiating and receiving return signals of electromagnetic energy, comprising the steps of:
generating and transmitting signals of electromagnetic energy having a incoherent phase characteristic,
mixing a sample of the transmitted signal with a signal from a reference signal source having a coherent phase characteristic and forming a resultant phase signal as a result of the signal mixing;
generating a signal having a predetermined optimum phase characteristic for the signal being transmitted;
comparing the resultant phase signal with the signal having said predetermined phase characteristic and generating a phase correction signal therefrom; and,
processing the return signals utilizing the phase correction signal and producing thereby a coherent phase characteristic in the return signals.

2. The method as defined by claim 1 wherein the local reference signal comprises a relatively frequency stable continuous wave (CW) signal.

3. The method as defined by claim 2 wherein said CW signal has a relatively narrow frequency bandwidth.

4. The method as defined by claim 3 wherein the transmitted signals of the electromagnetic energy comprise pulse signals in the optical wavelength region of the electromagnetic spectrum.

5. The method as defined by claim 4 wherein the pulse signals comprise laser pulse signals.

6. The method as defined by claim 5 wherein the sensor system comprises a laser radar system.

7. The method as defined by claim 6 wherein the transmitted laser pulse signals are frequency modulated.

8. The method as defined by claim 7 wherein the laser signals are linearly frequency modulated.

9. The method as defined by claim 8 wherein the laser pulse signals are frequency modulated by a substantially linear ramp control signal.

10. The method as defined by claim 9 and additionally including the step of linearizing the ramp control signal.

11. The method as defined by claim 7 wherein the step of processing the return signals further includes a step of initially correcting for the frequency modulation of the transmitted laser pulse signals.

12. The method as defined by claim 7 wherein the step of processing the return signals includes stretch processing and including initially providing a deramp frequency correction of the return signals followed by a deskew operation prior to applying the phase correction signal.

13. The method as defined by claim 10 wherein the step of producing a coherent phase in the return signal is carried out in relatively fast time and the step of linearizing the ramp signal for producing frequency modulation of the transmit signal is carried out in relatively slow time.

14. The method as defined by claim 13 and additionally including SAR processing of the return signals.

15. A method of processing signals in a pulsed laser radar system where the transmit pulses are frequency modulated and comprising the steps of:
generating a sequence of frequency modulated laser pulse signals having an inherent incoherent phase characteristic;
transmitting said laser pulse signals and receiving return signals of said laser pulse signals, said return signals also having the same incoherent phase characteristic as the transmitted signals;
mixing a sample of the transmitted laser pulse signals with a signal having a coherent phase characteristic from a relatively frequency stable optical signal reference source and providing a resultant phase signal generated as a result of the step of mixing;
generating a laser signal having an ideal phase characteristic for the transmitted laser pulse signals;
comparing the resultant phase signal with the laser signal having the ideal phase characteristic and generating therefrom a phase correction signal;
processing the return signals utilizing the phase correction signal so as to provide return signals having a substantially coherent phase characteristic.

16. The method as defined by claim 15 wherein the optical signal from the reference source comprises a continuous wave (CW) signal having a relatively narrow frequency bandwidth.

17. The method as defined by claim 16 where the transmitted laser pulse signals are linearly frequency modulated.

18. The method as defined by claim 15 wherein the step of processing the return signals comprises stretch processing including an initial step of providing a deramp frequency correction of the return signals followed by a deskew operation prior to applying the phase correction signal.

19. The method as defined by claim 17 wherein the linearly modulated transmit pulses are modulated by a ramp type signal and additionally including the step of linearizing the ramp signal.

20. The method as defined by claim 19 wherein the step of producing return signals having a substantially coherent phase characteristic is carried out in relatively fast time and the step of linearizing the ramp signal for producing frequency modulation of the transmit signal is carried out in relatively slow time.

21. The method as defined by claim 15 and additionally including the step of SAR signal processing of the return signals.

22. A system for radiating and receiving return signals of electromagnetic energy, comprising:
circuitry for generating and transmitting signals of electromagnetic energy having an incoherent phase characteristic,
a reference signal source of signals of electromagnetic energy having a coherent phase characteristic,
a signal mixer for heterodyning a sample of the transmitted signal with a signal from said reference signal source, and forming a phase signal therefrom,
an electromagnetic energy source having a predetermined phase characteristic for the signal being transmitted;
a signal comparator for comparing the phase signal with the signal having said predetermined phase characteristic and generating a phase correction signal therefrom; and,
a signal processor for processing the return signals utilizing the phase correction signal so as to produce a coherent phase characteristic in the return signals.

23. The system as defined by claim 21 wherein the reference signal source provides a relatively frequency stable continuous wave (CW) signal.

24. The system as defined by claim 23 wherein said CW signal has a relatively narrow frequency bandwidth.

25. The system as defined by claim 24 wherein the transmitted signals of the electromagnetic energy comprise pulse signals in the optical wavelength region of the electromagnetic spectrum.

26. The system as defined by claim 25 wherein the pulse signals comprise laser pulse signals.

27. The system as defined by claim 26 wherein the transmitted laser pulse signals are frequency modulated.

28. The system as defined by claim 27 wherein the laser signals are linearly frequency modulated.

29. The system as defined by claim 27 wherein the laser pulse signals are frequency modulated by a substantially linear signal generated by a ramp signal generator.

30. The system as defined by claim 29 wherein the signal processor includes means for initially correcting the return signals for the frequency modulation of the transmitted laser pulse signals.

31. The system as defined by claim 30 wherein the signal processor includes means for providing stretch processing and including signal processor circuit means for providing a deramp frequency correction of the return signals followed by a deskew operation before coherent phase correction of the return signals is produced.

32. The system as defined by claim 31 wherein the coherent phase correction of the return signals is produced in relatively fast time and linearization of the ramp signal for producing frequency modulation of the transmit signal is carried out in relatively slow time.

33. The system as defined by claim 22 wherein the signal processor includes means for providing SAR signal processing.

34. A radar system, comprising:
a transmit signal generator generating a sequence of frequency modulated pulse signals of electromagnetic energy having a random phase characteristic;
means for transmitting said pulse signals and receiving return signals of the pulse signals transmitted, said return signals also having the same phase characteristic as the transmitted pulse signals;
a reference signal source generating a relatively frequency stable reference signal;
a signal mixer for mixing a sample of the transmitted pulse signals with said reference signal and generating a pulse difference signal;
means for generating a signal having a desired phase characteristic for the transmitted pulse signals;
means for comparing the phase difference signal with the signal having the desired phase characteristic and generating a phase correction signal;
a signal processor for processing the return signals with the phase correction signal so as to correct the phase of the return signals so as to have a substantially coherent phase characteristic.

35. The radar system as defined by claim 34 wherein the reference signal comprises a continuous wave (CW) signal having a relatively narrow frequency bandwidth.

36. The radar system as defined by claim 35 where the transmitted pulse signals are frequency modulated by a ramp signal.

37. The radar system as defined by claim 36 and additionally including means for detecting the linearity of the frequency modulated transmitted pulse signal and correcting the linearity characteristic of the ramp signal.

38. The radar system as defined by claim 37 wherein the signal processor includes means for the return signals stretch processing and including means for deramping the frequency of the return signals and deskewing the deramped signals prior to phase correcting the deskewed signals.

39. The radar system as defined by claim 38 wherein said transmitted pulse signal comprises pulse signals in the optical wavelength region of the electromagnetic spectrum.

40. The radar system as defined by claim 39 wherein said pulse signals comprise laser pulse signals.
